(19) United States
(12) Patent Application Publication
(10) Pub. No.: US 2011/0027415 A1
(43) Pub. Date: Feb. 3, 2011

(54) FLEXIBLE DEPOSITING SYSTEM

(75) Inventors: Rodolfo De Acutis, York (GB); John Michael Leadbeater, York (GB)

Correspondence Address: K&L Gates LLP, P.O. Box 1135, CHICAGO, IL, 60690, US

(73) Assignee: NESTEC S.A., Vevey (CH)

(21) Appl. No.: 12/934,904

(22) PCT Filed: Mar. 25, 2009
(86) PCT No.: PCT/EP09/02174

§ 371 Date: Sep. 27, 2010

(30) Foreign Application Priority Data
Mar. 28, 2008 (EP) 08153561.9

(51) Int. Cl. A21B 5/02; A21D 10/04; A23P 1/10; A21D 8/04; A23L 1/27

(52) U.S. Cl. 426/18; 426/458; 426/389; 426/233; 426/250; 99/335; 99/334

(57) ABSTRACT

A method and apparatus of preparing a wafer by baking a batter which comprises preparing a batter mix comprising at least flour and water, feeding the batter mix intermittently in a batter stream to a batter depositor (22) which deposits batter onto a heated baking surface (23) wherein at an injection point in the batter stream immediately upstream of the batter depositor, at least one further batter ingredient is added to the batter mix to form the batter, depositing a portion of the batter onto the heated baking surface (23) to bake the batter in contact with the heated baking surface for a period of from 20 seconds to 5 minutes, at 130° C. to 220° C. to form the wafer, and removing the wafer from the heated baking surface characterized in that the batter is fed through an in-line mixing device (19) fitted at or downstream of the injection point.

### FIELD OF THE INVENTION

The present invention relates to the production of wafers and more particularly to the use of a flexible depositing system to enable versatility in the texture, colour or flavour of wafers during their production.

### BACKGROUND OF THE INVENTION

Two basic types of wafer are described by K. F. Tiefenbacher in “Encyclopaedia of Food Science, Food Technology and Nutrition p 417-420—Academic Press Ltd London—1993”:

1) No- or low-sugar wafers. The finished biscuits contain from zero to a low percentage of sucrose or other sugars. Typical products are flat and hollow wafer sheets, moulded cones or fancy shapes.
2) High-sugar wafers. More than 10% of sucrose or other sugars are responsible for the plasticity of the freshly baked sheets. They can be formed into different shapes before sugar recrystallization occurs. Typical products are moulded and rolled sugar cones, rolled wafer sticks and deep-formed fancy shapes.

Manufacturing no- or low-sugar wafers involves preparing a batter comprising a batter mix containing mainly flour and water to which other minor ingredients may be added. Typically 20 to 60% flour in batter is used in the manufacture of commercial no- or low-sugar wafers. Common formulations may also comprise at least one of the following ingredients: fat and/or oil, lecithin and/or emulsifiers, sugar, whole egg, salt, sodium bicarbonate, ammonium bicarbonate, skim milk powder, soy flour, yeast, and/or enzymes such as xylanases, proteases or alpha-amylase, for example.

In a common method of no- or low-sugar wafer manufacture, the batter is fed by pumping to a heated baking surface comprising a series of wafer baking moulds corresponding to the type of wafer desired, each wafer baking mould consisting of two heated engraved metal plates, also known as baking irons having upper and lower sections arranged to open and close, one of which may be moved relative to the other, The baking moulds are disposed one after the other, continuously circulating through a wafer oven by travelling from one end to the other and which are opened and closed in the front entrance of the wafer oven for the depositing of the batter and removal of the individual wafers. The wafer baking moulds pass through a baking oven for a determined time at a certain temperature, for instance 1-3 minutes at 140° C. to 180° C., to produce large flat wafer sheets with a low moisture content.

In another method of manufacture of no- or low-sugar wafers described in co-pending EP Application No. 06119953.5, the wafer baking moulds are stationary and independent of the others in the wafer baking apparatus. The apparatus comprises at least two baking moulds, each having one pair of top and lower baking plates, said apparatus further comprising moving means for moving at least one plate relative to the other so that each baking mould can move from a closed configuration to an open configuration, heating means for heating the plates to a predetermined baking temperature, means for depositing on or injecting a predetermined quantity of dough between the baking plates of each mould and means for removing a baked wafer from a baking mould, characterized in that each baking mould is stationary in the apparatus and is independent from the other(s).

For the production of hollow shaped wafers, the wafer sheet is obtained by baking the batter between shaped wafer baking plates, comprising a female plate and a male plate which between them, when placed together, form a space or cavity corresponding to the shaped wafer sheet.

After cooling, the wafers are processed according to the requirements of the final product. Wafers are baked products which are made from wafer batter and have crisp, brittle and fragile consistency. They are thin, with an overall thickness usually between <1 mm and 8 mm and typical product densities range from 0.05 to 0.8 g/cm3. The surfaces are precisely formed, following the surface shape of the plates between which they were baked. They often carry a pattern on one surface or on both.

Sugar wafers cones need a concentration of more than 25% sucrose or other sugars in the product. Sugar wafer cones are commonly produced by baking oval or round wafer sheets between baking plates in a similar manner to no- or low-sugar wafers and then stripping the wafer off the plate and rolling it while still hot on tapered mandrels to form the finished cone.

Sugar wafers can also be produced in a continuous strip, such as by depositing sugar wafer batter onto a moving hot surface such as a heated metal band or drum. Typically sugar wafer strips are rolled when hot to form a tube, but other shapes are also possible. Such processes are described in U.S. Pat. No. 6,254,916 and US2004250692.

However, there are problems in wafer production because, if the batter formulation containing the common ingredients is prepared in advance, some additives are sensitive to the residence time in the batter and, if left too long in the batter before baking, are capable of reacting in the batter to give non-desired by-products which lead to disadvantages. Some examples are as follows:

1) Maltodextrins if left too long in a no- or low-sugar wafer batter would react with the intrinsic alpha and beta amylase of the flour in the batter to produce maltose resulting in a steady deterioration of the batter. Maltose would give a very high stickiness on the plate and the wafer would be difficult to release.
Sticking wafers on an industrial automatic plant present a major problem as they are difficult to remove and end up being baked multiple times and spoiling a percentage of the oven's output until the oven is stopped and the plates cleaned.
2) Alpha Amylase, if left too long in the batter, would react in the batter with damaged starch resulting in a steady deterioration of the batter and give an extremely runny and liquid batter which results in a very fragile wafer.

It would therefore be advantageous to be able to prepare the basic batter mix composition comprising flour and water in advance and add the ingredients sensitive to the residence time (hereinafter referred to as “further batter ingredients”) in the batter immediately before the batter is deposited onto the heated baking surface, e.g. less than about two minutes before depending on the further ingredient and on the flow rate. The advantages of adding these further ingredients are most apparent the shorter this period of time which is preferably as short as possible.

We have found that one or more desired further batter ingredients may be added to the batter mix at an injection point in the batter stream to form the batter immediately before the batter is deposited onto the heated baking surface and by fitting an in-line mixing device downstream of (or at) the injection point, the above disadvantages can be alleviated or overcome. The in-line mixer should rapidly mix in the further ingredients to form a homogeneous batter.

### SUMMARY OF THE PRESENT INVENTION

According to one embodiment of the present invention there is provided a method of preparing a wafer by baking a batter which comprises preparing a batter mix comprising at least flour and water, feeding the batter mix intermittently in a batter stream to a batter depositor which deposits batter onto a heated baking surface wherein at an injection point in the batter stream immediately upstream of the batter depositor, at least one further batter ingredient is added to the batter mix to form the batter, depositing a portion of the batter onto the heated baking surface to bake the batter in contact with the heated baking surface for a period of from 20 seconds to 5 minutes, at 130° C. to 220° C. to form the wafer, and removing the wafer from the heated baking surface characterized in that the batter is fed through an in-line mixing device fitted at or downstream of the injection point.

### DETAILED DESCRIPTION OF THE INVENTION

When the heated baking surface is a wafer baking mould, this usually comprises two metal plates having upper and lower sections at least one of which is adapted to be moved relative to the other so that the baking mould can move from an open configuration for depositing the batter to a closed configuration for baking the batter and to an open configuration for removal of the baked wafers. Preferably the surface of one or both of the baking plates is engraved with a suitable pattern which is transferred to the surface of the wafer during baking.

The in-line mixing device should rapidly mix in the further ingredients to form a homogeneous batter and preferably, the in-line mixing device is a static mixer.

The further batter ingredient is added at the injection point in the batter stream by means of a dosing pump which is timed to run only when the batter feed pump runs.

The further batter ingredient is conveniently added to the batter mix at the injection point within 2 minutes of depositing the batter onto the heated baking surface, preferably within 60 seconds, more preferably within 30 seconds, and most preferably within 10 seconds before depositing onto the heated baking surface.

The duration of the baking of the batter is preferably from 20 seconds to 5 minutes, more preferably from 1 minute to 3 minutes, and most preferably from 90 seconds to 150 seconds. The temperature of the baking of the batter is preferably from 140° C. to 180° C., more preferably from 150° C. to 170° C.

Although the use of an in-line mixing device, fitted at or downstream of the injection point to blend the further additives with the batter mix to form the batter, overcomes the aforementioned problems regarding additives which are sensitive to the residence time in the batter, the use of an in-line mixing device can cause an increase in pressure. Ideally, batter should only be deposited when the baking plates are in the open configuration in the correct position beneath the batter depositor and then stopped when the plates are in the closed configuration. However, when the batter pump stops, the residual pressure generated in the static mixer causes the batter to continue to flow out of the system even when the plates are in the closed configuration causing waste.

We have found that by using a pressure retaining valve and preferably, in addition, a suckback system, this problem is alleviated or eliminated.

The presence of the pressure retaining valve substantially prevents the batter from dripping out of the batter stream when the batter pump stops and the baking plates are in the closed configuration.

A suitable pressure retaining valve is a pneumatic valve such as a pinch valve which is normally closed.

Preferably, fitted upstream of the batter depositor is a suckback cylinder adapted to be activated after the batter has been deposited in the baking mould to prevent batter dripping between batter deposits.

When the heated baking surface is a baking mould, the baking mould in the closed configuration containing the batter may conveniently be heated to form the wafer in a baking oven. In one embodiment, the baking mould may traverse the baking oven and, preferably there are a series of baking moulds disposed one after the other, continuously traversing the interior of the baking oven in the closed configuration and which after exiting the baking oven are moved to an open configuration for removing the individual wafers and depositing a further portion of batter and then moved to a closed configuration in which they traverse the oven.

Alternatively, the baking mould in the closed configuration containing the batter may be heated to form the wafer in a stationary position. Preferably, there may be two or more stationary baking moulds independent from the other(s) in the open configuration for depositing the batter, in the closed configuration for baking the batter and in the open configuration for removing the baked wafers.

The batter is conveniently fed by pumping intermittently so that the batter is deposited when the baking mould is in the open configuration and stops when the baking mould is in the closed configuration.

The wafer may be a flat wafer either having geometric shapes or cartoons character shapes, as well as alphabet letters or numbers, for example. It can also be a three dimensional shaped wafer such as, for example, a cone, a hemispherical shell, a hollow animal shape or other fancy shape.

As stated above, a batter mix for preparing wafers usually comprises from 20 to 60% flour. The batter itself commonly may also comprise at least one of the following further ingredients in addition to the batter mix: fat and/or oil, lecithin and/or emulsifiers, sugar, whole egg, salt, sodium bicarbonate, ammonium bicarbonate, skim milk powder, soy flour, yeast, and/or enzymes such as xylanases, proteases or alpha-amylase, for example. No- or low-sugar wafers usually contain about 0-10% sugar but sugar wafers may contain from 25% to 50% sugar.

Some of these ingredients may be present in the batter mix while any further batter ingredients are added to the batter mix immediately before deposition onto the heated baking surface conveniently by means of a dosing pump at an injection point in the batter stream to form the batter. The further batter ingredients are conveniently added to the batter mix within 2 minutes, preferably within 1 minute and more preferably within 30 seconds and even more preferably within 10 seconds of depositing the batter in the baking mould.

Examples of further batter ingredients which may advantageously be added to the batter mix at an injection point in the batter stream are maltodextrins, alpha-amylase, water, sugar syrups, more concentrated batter, suspensions of solids, colours, flavours, flavour precursors or enzymes. The addition of maltodextrin to the batter mix immediately before deposition into the baking mould so that it is not degraded results in a wafer which does not stick on the batter plate and produces a much crispier wafer product. The concentration of maltodextrin in the batter may be from 1% to 40% and preferably from 5% to 20% by weight. Similarly, the addition of alpha amylase to the batter mix immediately before deposition into the baking mould, so that it does not have sufficient time to react in the batter with damaged starch in the batter results in a much crisper wafer. The addition of enzymes just before batter deposition into the baking mould makes it possible to use different enzymes which would otherwise lead to undesirable changes in the batter if added to the batter earlier. The concentration of enzyme in the batter may be from 0.0005 to 0.1% and preferably from 0.001 to 0.04% by weight.

Often, industrial wafer plants have one batter plant for preparing the batter mix but several ovens. With regard to the addition of water, the amount of water in the batter is crucial for the final wafer texture. If different amounts of water are added to the batter mix at different ovens immediately before the deposition of the batter onto the heated baking surface, then it would be possible to have a different batter texture in each oven enabling a much higher versatility of batter texture to be achieved although only one batter mix is produced in the batter plant. For example, the amount of added water to the batter mix may range from 5% to 50% and preferably from 10% to 25% of the standard water addition.

Additions of colours or flavours (or reaction mixtures which generate flavour when baked in the wafer) to the batter mix immediately before the deposition of the batter onto the heated baking surface, would also increase the versatility of the ovens whereby wafers having a variety of colours or flavours may be produced although only one batter mix is produced in the batter plant. The concentration of colour or flavour in the batter may vary hugely depending on the type of colour and flavour and whether they are contained in a carrier material. The colours to be added may be suspended or dissolved in water or sugar solution. A skilled person would be able to determine an appropriate level depending on the colour or flavour to be added taking into account any appropriate legislation. For example, the concentration of colour or flavour may be from 5 ppm to 100 ppm and preferably from 10 ppm to 40 ppm based on the weight of the batter if the material is not diluted/or suspended in water and/or sugar syrups.

For example, if one or more further batter ingredients, e.g. water, colour or flavour, are to be added in different amounts to a batter mix in a system using a plurality of baking ovens, each further batter ingredient may conveniently be stored in a separate storage vessel each with a dosing pump and separate feed pipes for the different amounts of further batter ingredients to be added to the batter mix to form the batter immediately before the deposition of the batter onto the heated baking surfaces at different ovens to give the desired batter in a specific oven.

It should be understood that if it is not desired to add any one or more of the further batter ingredient for any particular oven, then the appropriate dosing pump would be shut down.

The duration of the baking of the batter in the baking mould as it passes through the baking oven is preferably from 90 seconds to 150 seconds and the temperature is preferably from 150° C. to 170° C.

According to a second embodiment of the present invention there is provided an apparatus for preparing a wafer which comprises a storage vessel for a batter mix fitted with a batter feed pump for intermittent action, a storage vessel for further batter ingredients fitted with a dosing pump timed to run only when the batter feed pump runs, a feed line for the batter, a feed line for the further batter ingredients, an injection point connected to the dosing pump for feeding further batter ingredients into the feed line for the batter, and a heated baking surface, means for depositing batter onto the heated baking surface, means for heating the baking surface to a predetermined temperature for baking the batter to form the wafer, and means for removal of the baked wafer from the heated baking surface characterised in that an in-line mixing device is fitted at or downstream of the injection point.

The heated baking surface may be a wafer baking mould. The wafer baking mould may conveniently comprise two metal plates having upper and lower sections at least one of which is adapted to be moved relative to the other so that the baking mould can move from an open configuration for depositing the batter to a closed configuration for baking the batter and to an open configuration for removal of the baked wafers. Preferably the surface of one or both of the baking plates is engraved with a suitable pattern which is transferred to the surface of the wafer during baking.

Preferably, the in-line mixing device is a static mixer.

Preferably, a pressure-retaining valve is fitted downstream of the static mixer to prevent flow of batter onto the heated baking surface when the batter pump stops.

The pressure retaining valve is preferably a pneumatic valve, e.g. a pinch valve.

Advantageously, fitted upstream of the batter depositor is a suckback cylinder adapted to be activated after the batter has been deposited onto the heated baking surface.

Depending on the nature of the batter feed pump and the dosing pump for further ingredients, it may be advantageous to include a non-return valve between the pumps and the injection point to maintain pressure. The presence of a non return valve in each pump flow outlet stops the flow from one pump going back up the outlet pipe of the other.

The means for depositing batter in the baking mould may be provided by a batter arm, well known to those skilled in the art, which is a pipe spanning the open batter plate with a series of small holes spaced to supply a series of streams of batter in rows across the width of the open bottom plate. The pipe may have a diameter of from 15 mm to 40 mm with from 4 to 40 holes having a variable diameter from 1.0 mm to 10.0 mm.

In one embodiment, a suitable means for heating the baking mould is a baking oven which may be, for instance, gas-fired or electrically heated. Conveniently, the baking mould is adapted to traverse the baking oven in the closed configuration for baking the batter

Advantageously, there are a series of baking moulds disposed one after the other, adapted to continuously traverse the interior of the baking oven in the closed configuration for baking to form the wafer, and on exiting the baking oven, adapted to be moved to an open configuration for removing the individual wafers and depositing a further portion of batter. Another suitable means for heating the baking moulds traversing the baking oven is by means of individually electrically heated plates.

In another embodiment, the baking mould containing the batter is adapted to be heated by a heating means in a stationary position. Conveniently there are two or more stationary baking moulds independent from the other(s) in the open configuration for depositing the batter, in the closed configuration for baking the batter and in the open configuration for removing the baked wafers.

Other suitable means for heating the baking moulds in a stationary position may comprise

a) a low frequency induction heating system embedded into the top and lower plates of each mould,
b) a system of steam heated pipes disposed in the body of the baking plate, or
c) a system of pipes incorporated into the baking plates, said pipes conveying a pumped hot fluid.

The present invention enables the creation of crispier wafers by the addition of materials sensitive to the residence time in the batter. In addition, the present invention improve the versatility of the wafer making process where there is one batter plant and a plurality of ovens so that a variety of wafer textures by adding water immediately before the deposition stage into the baking mould so that the batter plant would be able to continue to produce one single batter for all ovens. The present invention also enables the production of wafers having a variety of flavours and/or colours by adding flavours or colours immediately before the deposition stage onto the heated baking surface and not at the batter plant so that every oven can have different colour and/or flavour.

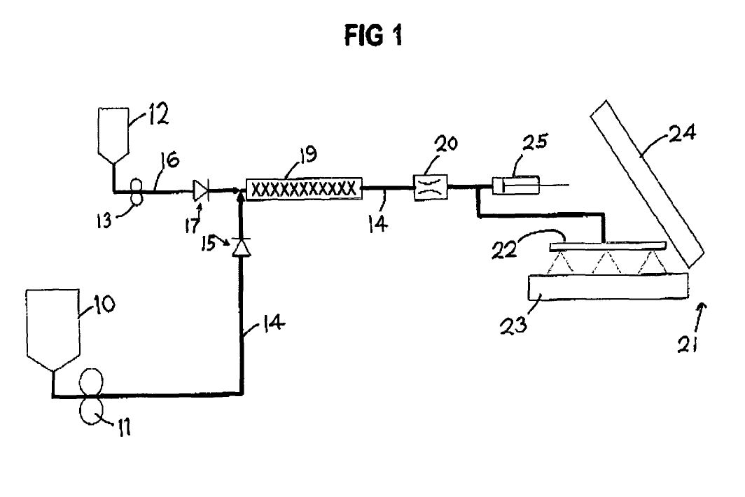

The present invention is further illustrated with reference to the accompanying drawing in which FIG. 1 depicts an apparatus for depositing batter in a baking mould.

Referring to the drawing, a storage tank (10) for a batter mix is provided with a feed pump (11) adapted to run intermittently. A storage vessel (12) for a further batter ingredient is provided with a dosing pump (13) adapted to run at the same time as the feed pump (11). A batter feed pipe (14) fitted with a non-return valve (15) for transporting the batter mix and an additive feed pipe (16) fitted with a non-return valve (17) for transporting the additive meet at an injection point (18) for injecting the additive into the batter mix. Immediately downstream of the injection point (18) in the batter feed pipe (14) is an in-line static mixer (19) for blending the additive with the batter mix to form the batter. Downstream of the static mixer is a pinch valve (20). Downstream of the pinch valve the batter feed pipe (14) leads to a batter arm (22), positioned to deposit batter into the baking mould (21). The baking mould comprises a lower engraved wafer baking plate (23) and an upper engraved wafer baking plate (24) as it traverses (in a direction coming out of the drawing) a wafer oven (not shown) by travelling from one end to the other and which plates (23), (24) are adapted to be opened and closed in the front entrance of the wafer oven for the depositing of the batter and removal of the individual wafers.

A suck-back cylinder (25) is fitted between the pinch valve (20) and the batter arm (22)

### EXAMPLES

The following Examples are illustrative of some of the products and methods of making the same falling within the scope of the present invention. They are not to be considered in any way limitative of the invention. Changes and modifications can be made with respect to the invention. That is, the skilled person will recognise many variations in these examples to cover a wide range of formulas, ingredients, processing, and mixtures to rationally adjust the naturally occurring levels of the compounds of the invention for a variety of applications.

### Example 1

A batter mix is prepared comprising 5000 g of wheat flour, 5900 g of water, 50 g of fat, 22 g of salt and 5 g of sodium bicarbonate and stored in a storage tank (10) provided with a feed pump (11) adapted to run intermittently. An additive comprising a mixture of 10 g alpha-amylase made up to 1000 g with water is stored in a storage vessel (12) provided with a dosing pump (13) adapted to run at the same time as the batter mix is pumped. When operating, the feed pump (11) transports the batter mix through a batter mix feed pipe (14) fitted with a non-return valve (15) to a baking mould (21) and simultaneously the dosing pump (13) transports the alpha-amylase solution through an additive feed pipe (16) fitted with a non-return valve (17) to an injection point (18) where the feed pipes (14) and (16) meet and an amount of alpha-amylase solution is injected into the batter mix in the feed pipe (14) 30 seconds before the batter is deposited in the baking mould (21), to give an enzyme concentration of alpha-amylase enzyme in the final batter of 0.01% by weight.

### Composition of Final Batter:

| Ingredient | % | kg |
|---|---|---|
| Flour | 45.09 | 5.000 |
| Water | 53.21 | 5.900 |
| Vegetable fat | 0.45 | 0.050 |
| Salt | 0.20 | 0.022 |
| Sodium Bicarbonate | 0.05 | 0.005 |
| Alpha amylase (1% aqueous mix) | 1.00 | 0.111 |
| Total | 100 | 11.077 |

The mixture of alpha-amylase solution and batter mix then flows through a static mixer (19) where it is blended to form the batter. The batter continues to flow in the feed pipe (14) and passes through a pinch valve (20) to a batter arm (22) which deposits batter between a lower wafer baking plate (23) and an upper wafer baking plate (24) of the baking mould (21) when they are in the open position

The pinch valve (20) prevents the flow of batter to the batter arm when the batter pump stops A suckback cylinder (25) fitted after the pinch valve is activated after the end of the batter deposit to prevent batter dripping between deposits.

The baking mould (21) consists of two heated engraved metal plates having upper and lower sections arranged to open and close, one of which may be moved relative to the other, which plates traverse a wafer oven by travelling from one end to the other and which are opened at the front entrance of the wafer oven for the depositing of the batter and then closed as they pass through the baking oven for 2 minutes at 160° C. to produce large flat wafer sheets with a low moisture level which are cooled and processed according to requirements. On returning to the front entrance the wafer plates open to allow the removal of the individual wafers and to allow the deposit of further batter. After the batter deposit, the feed pump (11) and the dosing pump (13) stop until the next baking moulds (21) reaches the front entrance of the wafer oven whereupon the pumps restart and the cycle recommences, i.e. the baking plates (23) and (24) open to allow the removal of the individual wafers and to allow the deposit of further batter. When the feed pump (11) and the dosing pump (13) stop, the pinch valve (20) prevents the flow of batter to the batter arm and the suckback cylinder (25) is activated to prevent batter dripping between deposits. The moisture content of the wafer leaving the oven is from 1-2%.

### Example 2

A similar procedure to that described in Example 1 is followed wherein a batter mix is prepared comprising 5000 g of wheat flour, 6000 g of water, 50 g of fat, 22 g of salt and 5 g of sodium bicarbonate and stored in a storage tank (10) provided with a feed pump (11) adapted to run intermittently. Instead of the alpha-amylase solution, water is stored in a storage vessel (12) provided with a dosing pump (13) adapted to run at the same time as the batter mix is pumped. Extra water is added to the batter mix at the injection point to give a final water content of the batter of 59%. By increasing the amount of water in the batter the density of the wafer after baking is reduced compared to a wafer baked with the original batter mix. The texture of the finished wafer is lighter, having a softer first bite, but maintaining its crispness and melting more rapidly in the mouth.

1. A method of preparing a wafer by baking a batter comprising:
preparing a batter mix comprising at least flour and water;
feeding the batter mix intermittently in a batter stream to a batter depositor which deposits batter onto a heated baking surface wherein at an injection point in the batter stream immediately upstream of the batter depositor, at least one further batter ingredient is added to the batter mix to form the batter, the batter is fed through an in-line mixing device fitted at or downstream of the injection point;
depositing a portion of the batter onto the heated baking surface to bake the batter in contact with the heated baking surface for a period of from 20 seconds to 5 minutes, at 130° C. to 220° C. to form the wafer; and
removing the wafer from the heated baking surface.

2. A method according to claim 1 wherein the heated baking surface is a wafer baking mold.

3. A method according to claim 2 wherein the wafer baking mold comprises two metal plates having upper and lower sections, at least one of the sections is adapted to be moved relative to the other section so that the baking mold can move from an open configuration for depositing the batter to a closed configuration for baking the batter and to an open configuration for removal of the baked wafers.

4. A method according to claim 1 wherein the in-line mixing device is a static mixer.

5. A method according to claim 1 wherein the further batter ingredient is added at the injection point in the batter stream using a dosing pump which is timed to run only when the batter feed pump runs.

6. A method according to claim 1 wherein the further batter ingredient is added to the batter mix at the injection point within 2 minutes of depositing the batter onto the heated baking surface.

7. A method according to claim 1 wherein a pressure-retaining valve is positioned downstream of the in-line mixing device to prevent a flow of batter to the baking mold when the batter pump stops.

8. A method according to claim 7 wherein the pressure retaining valve is a pneumatic pinch valve.

9. A method according to claim 1 wherein, positioned upstream of the batter depositor is a suckback cylinder adapted to be activated after the batter has been deposited in the baking mold preventing batter dripping between batter deposits.

10. A method according to claim 1 wherein the further batter ingredients added to the batter mix at an injection point in the batter stream comprise an ingredient selected from the group consisting of maltodextrins, alpha-amylase, water, sugar syrups, more concentrated batter, suspensions of solids, colours, flavours, flavour precursors and enzymes.

11. A method according to claim 3 wherein the baking mold when in the closed configuration and containing the batter is heated to form the wafer in a baking oven.

12. A method according to claim 11 wherein the baking mold traverses the baking oven.

13. A method according to claim 12 comprising a series of baking molds disposed one after the other, continuously traversing an interior of the baking oven in the closed configuration and which after exiting the baking oven are moved to an open configuration for removing the individual wafers and depositing a further portion of batter and then moved to a closed configuration in which they traverse the oven.

14. A method according to claim 11 wherein there is one batter plant for preparing the batter mix and a plurality of baking ovens.

15. A method according to claim 14 wherein one or more further batter ingredients are added in different amounts to the batter mix in a system using a plurality of baking ovens, each further batter ingredient is stored in a separate storage vessel each with a dosing pump and separate feed pipes for the different amounts of further batter ingredients which are added to the batter mix to form the batter immediately before the deposition of the batter onto the heated baking surfaces at different ovens to give the desired batter in a specific oven.

16. A method according to claim 14 wherein the further batter ingredients comprise ingredients selected from the group consisting of water, colour and flavour.

17. A method according to claim 3 wherein the baking mold when in the closed configuration and containing the batter is heated to form the wafer in a stationary position.

18. A method according to claim 17 wherein there are at least two stationary baking molds independent from the other(s) in the open configuration for depositing the batter, closed configuration for baking the batter and open configuration for removing the baked wafers.

19. A method according to claim 3 wherein the batter is fed by intermittent pumping so that the batter is deposited when the baking mold is in the open configuration and stops when the baking mold is in the closed configuration.

20. An apparatus for preparing a wafer comprising:
a storage vessel for a batter mix fitted with a batter feed pump for intermittent action;
a storage vessel for further batter ingredients fitted with a dosing pump timed to run only when the batter feed pump runs;
a feed line for the batter;
a feed line for the further batter ingredients;
an injection point connected to the dosing pump for feeding further batter ingredients into the feed line for the batter;
a heated baking surface;
means for depositing batter onto the heated baking surface;
means for heating the baking surface to a predetermined temperature for baking the batter to form the wafer;
means for removal of the baked wafer from the heated baking surface; and
an in-line mixing device is positioned at or downstream of the injection point.

21. An apparatus according to claim 20 wherein the heated baking surface is a wafer baking mold.

22. An apparatus according to claim 21 wherein the wafer baking mold comprises two metal plates having upper and lower sections at least one of which is adapted to be moved relative to the other so that the baking mold can move from an open configuration for depositing the batter to a closed configuration for baking the batter and to an open configuration for removal of the baked wafers.

23. An apparatus according to claim 22 wherein the surface of at least one of the baking plates is engraved with a suitable pattern which is transferred to the surface of the wafer during baking.

24. An apparatus according to claim 20 wherein the in-line mixing device is a static mixer.

25. An apparatus according to claim 20 wherein a pressure-retaining valve is positioned downstream of the in-line mixing device.

26. An apparatus according to claim 25 wherein the pressure retaining valve is a pneumatic valve.

27. An apparatus according to claim 20 wherein positioned upstream of the baking mould is a suckback cylinder adapted to be activated after the batter has been deposited onto the heated baking surface.

28. An apparatus according to claim 20 wherein a non-return valve is positioned between the batter feed pump and the dosing pump for further ingredients at the injection point.

29. An apparatus according to claim 21 wherein the means for heating the baking mold is a baking oven.

30. An apparatus according to claim 29 wherein the baking mold is adapted to traverse the baking oven in the closed configuration for baking the batter.

31. An apparatus according to claim 29 wherein there are a series of baking molds positioned one after the other, designed to continuously traverse the interior of the baking oven in the closed configuration for baking to form the wafer, and on exiting the baking oven, adapted to be moved to an open configuration for removing the individual wafers and depositing a further portion of batter.

32. An apparatus according to claim 21 wherein the baking mold containing the batter is designed to be heated by a heating means in a stationary position.

33. An apparatus according to claim 32 wherein there are at least two stationary baking molds independent from the other(s) in the open configuration for depositing the batter, closed configuration for baking the batter and open configuration for removing the baked wafers.

34. An apparatus according to claim 32 wherein the heating means comprises a low frequency induction heating system embedded in the top and lower plates of each mold.

35. An apparatus according to claim 32 wherein the heating means comprises a system of steam heated pipes located in the body of the baking plate.

36. An apparatus according to claim 32 wherein the heating means comprise a system of pipes incorporated in the baking plates, the pipes feeding a heated fluid that is pumped.

37. An apparatus for preparing a wafer comprising:
a storage vessel for a batter mix having a batter feed pump;
a storage vessel for further batter ingredients fitted with a dosing pump;
a feed line for the batter;
a feed line for the further batter ingredients;
an injection point connected to the dosing pump for feeding further batter ingredients into the feed line for the batter;
a heated baking surface;
a member that deposits batter onto the heated baking surface;
a heater that heats the baking surface to a predetermined temperature for baking the batter to form the wafer;
a device removing the baked wafer from the heated baking surface; and
an in-line mixing device positioned at or downstream of the injection point.
